(19) United States
(12) Patent Application Publication
(10) Pub. No.: US 2020/0331051 A1
(43) Pub. Date: Oct. 22, 2020

(54) Real-time Control Apparatus for Punch

(71) Applicant: Mingxu(Dongguan)Precision Machinary Co., LTD., Dongguan (CN)

(72) Inventor: TaiKuo Wang, Dongguan (CN)

(73) Assignee: Mingxu(Dongguan)Precision Machinary Co., LTD., Dongguan, Guangdong (CN)

(21) Appl. No.: 16/396,746

(22) Filed: Apr. 28, 2019

(30) Foreign Application Priority Data
Apr. 17, 2019 (CN) 201910309993.3

(51) Int. Cl. B21D 28/04; B26F 1/40

(52) U.S. Cl. CPC B21D 28/04; B26F 2001/407; B26F 1/40

(57) ABSTRACT

The present disclosure relates to the technical field of punch, in particular, to a real-time control apparatus for punch. The real-time control apparatus of a punch includes an upper seat, a middle seat and a base. Its bottom of the upper seat is provided with a lifting seat connecting with an oil cylinder; the upper seat is provided with a driving mechanism, which connects and drives a slider to move towards the base to close to its bottom dead centre of the slider, the oil cylinder is activated, pushing the lifting seat to raise a H distance, thereby lifting the upper seat the H distance. The slider is also raised the H distance so as to compensate the H distance falling due to the inertia of the slider, so that the slider stops at its bottom dead centre.

### CROSS-REFERENCE TO RELATED APPLICATIONS

This application claims the benefit of priority from Chinese Patent Application No. CN201910309993.3, filed on Apr. 17, 2019. The content of the aforementioned application, including any intervening amendments thereto, is incorporated herein by reference in its entirety.

### TECHNICAL FIELD

The present disclosure relates to the technical field of punch, in particular, to real-time control apparatus for punch.

### BACKGROUND

Punch is an advanced basic processing equipment of modern manufacturing industry. According to the type of main drive, it can be divided into mechanical punch and hydraulic punch. It is widely used in the automotive industry, agricultural machinery, household appliances, electronic instruments, national defense industry and daily necessities and other production department.

The punch includes the upper seat, the middle seat and the base. The upper seat is the driving mechanism of the punch machine. the middle seat is provided with a slider, which is a moving part to complete the dynamic action of stamping. The base is a static support structure, the base also contains a fuel tank, which is an important part of the lubrication system.

When stamping, the driving mechanism drives the slider to move down to the bottom dead centre quickly. Due to the role of inertia, the slider can not accurately stop the position of the dead point, and it usually continues to move downward, thus affecting the precision of the stamping product, increasing the reject ratio.

The precision of the bottom dead centre is the most important technical index of the punch, which reflects the manufacturing level of the punch. At the same time, it can affect the precision of the stamping parts and determine the service life of the die. Therefore, it is urgent to develop a real-time control device to solve the defects of the prior art.

### SUMMARY

In order to overcome the deficiency of the prior art, the present disclosure provides a real-time control apparatus of the punch, which solves the technical problem that the slider can not accurately stop at the bottom dead centre, and improves the precision of the punch and the qualified rate of the stamping products.

The technical proposals of the present disclosure are as follows: real-time control apparatus of a punch includes an upper seat, a middle seat and a base. Its bottom of the upper seat is provided with a lifting seat connecting with an oil cylinder; the upper seat is provided with a driving mechanism, which connects and drives a slider to move towards the base to close to its bottom dead centre of the slider, the oil cylinder is activated, pushing the lifting seat to raise a H distance, thereby lifting the upper seat the H distance. The slider is also raised the H distance so as to compensate the H distance falling due to the inertia of the slider, so that the slider stops at its bottom dead centre.

Preferably, the lifting seat is fixed on the middle seat to support the upper seat.

Preferably, the lifting seat includes a bearing platform on which a groove is provided, the groove is provided with a gasket, the top of the gasket meets the bottom of the upper seat, and a first through hole is provided in the bearing platform. The first through hole is connected with the oil cylinder and the groove.

Preferably, the punch also includes a supporting rod arranged in the base, passing through the middle seat and inserting the upper seat.

Preferably, the supporting rod passes through the lifting seat.

Preferably, its center of the bearing platform is provided with a column hole, the supporting rod passes through the column hole, and the centre of the gasket is provided with a second through hole, the supporting rod is sheathed out of the column hole through the second through hole.

Preferably, its periphery of the gasket is provided with a sealing ring, it is provided with a gap between the gasket and the bearing platform, the sealing ring seals the gap.

Preferably, the lifting seat is provided with a plurality of positioning pins, its top of the middle seat and its bottom of the upper seat are respectively provided with lower holes and upper holes matched with the positioning pins.

Preferably, the lifting seat is provided with 4, respectively fixed at its four corners of its bottom of the upper seat.

Preferably, the supporting rod is four, respectively arranged at its four corners of the base.

The beneficial effect of the present disclosure is: the real-time control apparatus of the punch is provided with a lifting seat at the bottom of the upper seat of the punch, the lifting seat is connected to the oil cylinder. The slider moves toward the base to its bottom dead centre, and the slider will continue to move down a distance under the action of inertia, suppose the distance is H. When the slider is close to the bottom dead centre, the oil cylinder is activated to push the lifting seat upward the H distance, thereby lifting the slider the H distance, thereby compensating the H distance falling due to inertia of the slider, and stopping the slider at the bottom dead centre. The real-time control apparatus of the punch greatly improves the precision of the punch, which is reachable 0.01 mm.

### BRIEF DESCRIPTION OF THE DRAWINGS

FIG. 1 is a perspective view of the punch according to the present disclosure.

FIG. 2 is an exploded view of the punch according to the present disclosure, which shows the structure of the real-time control apparatus of the punch.

FIG. 3 is a perspective view of the real-time control apparatus of the punch according to the disclosure.

### DETAILED DESCRIPTION OF EMBODIMENTS

In order to make the inventive purpose of the disclosure clearer and clearer, the technical scheme and the technical effect of the disclosure are further explained in combination with the concrete embodiment below. It should be understood that the specific embodiments described herein are intended to explain the disclosure only and not to limit the protection scope of the claim.

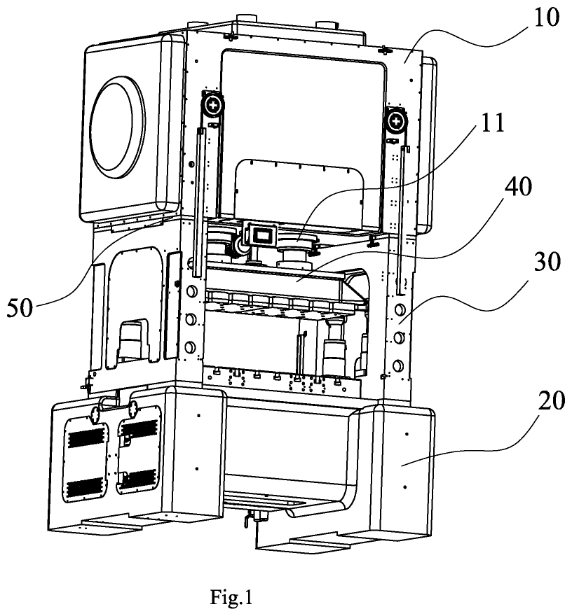

Referring to FIG. 1, a common punch includes an upper seat 10 and a base 20 arranged up and down, and a middle seat 30 between the two. The upper seat 10 is provided with a driving mechanism 11. The driving mechanism 11 connects and drives the slider 40 up and down. When the slider 40 moves down to the bottom dead centre, it will continue to move downward a certain distance due to inertia, the distance is recorded as H.

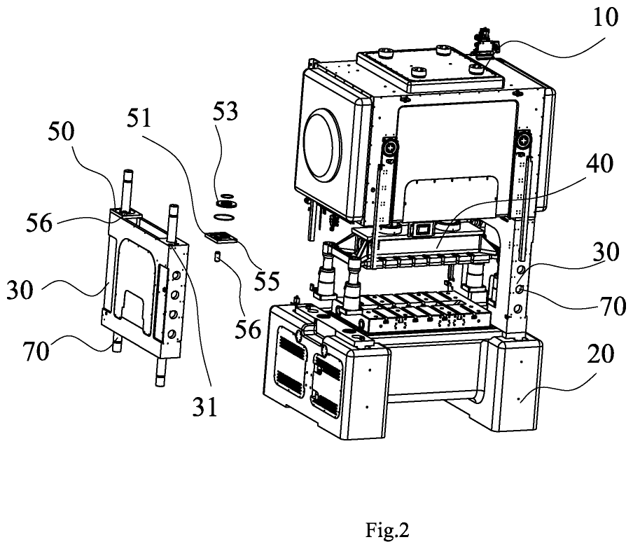

Referring to FIG. 2, its bottom of the upper seat 10 is provided with a lifting seat 50 connected to an oil cylinder (not shown). When the driving mechanism 11 drives the slider 40 to move towards the base 20 to close to the bottom dead centre, the oil cylinder is activated, pushing the lifting seat 50 to raise the H distance, thereby lifting the upper seat 10 upwards by the H distance. The slider 40 is also lifted by the H distance so as to compensate for the H distance falling due to the inertia of the slider 40, so that the slider 40 stops at the bottom dead centre.

It should be understood that the lifting seat 50 should be provided symmetrically at its bottom of the upper seat 10 in order to force the upper seat 10 evenly and lift it smoothly. In some embodiments of the disclosure, the lifting seat 50 is provided with four, respectively, fixed at its bottom quadrangle of the upper seat 10. Thus, the lifting seat 50 can smoothly lift the upper seat 10 to avoid tilting the upper seat 10.

In some embodiments of the present disclosure, the lifting seat 50 is fixed on the middle seat 30 to support the upper seat 10, and the installation of the lifting seat to is convenient.

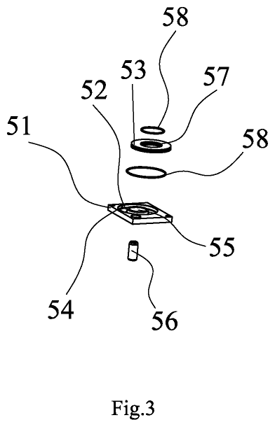

Referring to FIGS. 2 and 3, in some embodiments of the present disclosure, the lifting seat 50 includes a bearing platform 51 on which a groove 52 is provided, the groove 52 is provided with a gasket 53, its top of the gasket 53 is mounted to the bottom of the upper seat 10. The bearing platform 51 is provided with a first through hole 54 connected to the oil cylinder and the recess 52. When the lifting seat 50 needs to be lifted, the oil cylinder injects oil through the first through hole 54 into the groove 52, and the gasket 53 rises the H distance under the action of oil pressure, thereby lifting the upper seat 10 the H distance and the slider 40 is also lifted the H distance.

Referring to FIG. 2, in some embodiments of the present disclosure, the punch also includes a supporting rod 70 arranged in the base 20, passing through the middle seat 30 and inserting the upper seat 10. The supporting rod 70 fixes the relative position of the upper seat 10, the middle seat 30 and the base 20 to prevent the relative displacement from occurring, thereby affecting the precision of the punch.

Preferably, the supporting rod 70 is four, respectively arranged at its four corners of the base 20, passing through the middle seat 30 and inserting its four corners of the upper seat 10.

Referring to FIG. 2, in some embodiments of the disclosure the supporting rod 70 passes through the lift 50. In particular, its centre of the bearing platform 51 is provided with a column hole 55, the supporting rod 70 passes through the column hole 55, its center of the gasket 53 is provided with a second through hole 57, and is sheathed out of the column hole 55 through the second through hole. The supporting rod 70 also limits the position of the lifting seat 50 and improves the precision of the punch.

Referring to FIG. 2, in some embodiments of the disclosure, the lifting seat 50 is provided with a plurality of positioning pins 56, the top of the middle seat 30 and the bottom of the upper seat 10 are provided with a lower holes 31 and an upper holes (not displayed) matching the positioning pins 56, respectively.

Preferably, its periphery of the gasket 53 is provided with a sealing ring 58. It is provided with a gap between the bearing platform 51 and the gasket 53. The sealing ring 51 seals the gap to prevents oil leakage.

The above is a further detailed description of the disclosure in connection with the specific embodiments and is not to be construed as limited to the specific embodiments of the disclosure. For the ordinary technical personnel belonging to the technical field of the disclosure, the structure form of the disclosure can be flexible and changeable and a series of products can be derived under the premise that the disclosure is not separated from the conception of the disclosure. Mere deductions or replacements shall be deemed to fall within the scope of patent protection determined by the submitted claim.

1. A real-time control apparatus of a punch, said punch includes an upper seat with bottom, a middle seat and a base; said real-time control apparatus comprises a lifting seat arranged on said bottom of said upper seat; said upper seat is provided with a driving mechanism for connecting and driving a slider to move up and down towards said base, when said slider is close to said slider's bottom dead centre; said real-time control apparatus activates said lifting seat to raise a distance, thereby lifting said upper seat said distance; said slider is also raised said distance so as to compensate said distance falling due to inertia of said slider, therefor said slider stops at said slider's bottom dead centre;
wherein said lifting seat is fixed on said middle seat for supporting said upper seat;
wherein said lifting seat includes a bearing platform with a groove and having the function of oil cylinder, said groove is provided with a gasket with a top, said top of said gasket meets said bottom of said upper seat, and a first through hole is provided in said bearing platform and connected with said groove.

2. (canceled)

3. (canceled)

4. The real-time control apparatus of a punch according to claim 1, wherein said punch also includes a-supporting rods arranged in said base, said supporting rods pass through said middle seat and insert said upper seat.

5. The real-time control apparatus of a punch according to claim 4, wherein said supporting rods pass through said lifting seat.

6. The real-time control apparatus of a punch according to claim 5, wherein said bearing platform is provided with a column hole at centre, each of said supporting rods passes through said column hole, and said gasket is provided with a second through hole at centre, said supporting rod is sheathed out of said column hole through said second through hole.

7. The real-time control apparatus of a punch according to claim 6, wherein said gasket having periphery, said periphery is provided with a sealing ring, a gap is formed between said gasket and said bearing platform, said sealing ring seals said gap.

8. The real-time control apparatus of a punch according to claim 1, wherein said lifting seat is provided with a plurality of positioning pins, said middle seat having top, said top is provided with lower holes, and said bottom of said upper seat is provided with upper holes, said lower holes and said upper holes matched with said positioning pins.

9. The real-time control apparatus of a punch according to claim 1, wherein number of said lifting seat is, respectively fixed at four corners of said bottom of said upper seat.

10. The real-time control apparatus of a punch according to claim 1, wherein number of said supporting rods is four, respectively arranged at its four corners of said base.

11. (canceled)

12. (canceled)

13. (canceled)

14. (canceled)

15. (canceled)
